(19) United States
(12) Patent Application Publication
(10) Pub. No.: US 2011/0276873 A1
(43) Pub. Date: Nov. 10, 2011

(54) System and Method for Re-Using XBRL-Tags Across Period Boundaries

(76) Inventors: Chethan Gorur, Plano, TX (US); Nathan Hoover, Los Gatos, CA (US); Wayne Clingingsmith, Mountain View, CA (US); Dave Sprague, Scotts Valley, CA (US)

(21) Appl. No.: 13/103,032

(22) Filed: May 6, 2011

Related U.S. Application Data
(60) Provisional application No. 61/332,117, filed on May 6, 2010.

(51) Int. Cl. G06F 17/00

(52) U.S. Cl. 715/234

(57) ABSTRACT

An XBRL tag re-usable across period boundaries includes at least one definitional attribute and at least one transactional attribute, wherein the at least one transactional attribute is updated for each period.

### CROSS-REFERENCE TO RELATED APPLICATIONS

This application claims the benefit of U.S. Provisional Application No. 61/332,117, filed May 6, 2010, which application is hereby incorporated herein by reference, in its entirety.

### TECHNICAL FIELD

The invention relates generally to financial reporting and, more particularly, to a system and method for re-using XBRL-tags for financial reporting across time period boundaries.

### BACKGROUND

A typical filer of financial reports will submit multiple quarterly reports (one per quarter, also known as 10Q reports), and one annual report (one per year, also known as 10K reports or 20F reports). Conventional filers prepare and submit such reports multiple times a year in a form called Edgarized HTML (referred to herein as “HTML report”). These financial reports are typically relatively large documents (often ranging in length from 50 to over 100 pages, depending on complexity) containing information about financial statements, notes, management discussion, analysis, and other related information as required by the Securities and Exchange Commission (“SEC”).

Extensible Business Reporting Language (“XBRL”) is a technology standard that can be applied to the creation of financial statement data and other reporting situations. XBRL is an application of Extensible Markup Language (“XML”) to business information and it uses tags or structure to describe the data, making it immediately reusable, interactive and intelligent. It is also “extensible” so it can be customized for unique situations and reporting concepts.

For regulators and accountants, XBRL allows financial information to be uniquely identified using a tag. Once an item or piece of financial information is tagged, it can be used consistently throughout various and diverse reports that contain that particular item or piece of financial information.

For investors, XBRL pinpoints all of the facts and figures trapped in current financial documents, allowing investors to immediately pull out exactly the information they want, and instantly compare it to the results of other companies.

XBRL is a royalty-free technology developed and maintained by XBRL International, a not-for-profit consortium comprising over 800 accounting, technology, financial services, and regulatory-type organizations across the world. In addition, every local jurisdiction (e.g., a specific geographical region or country) develops and maintains taxonomies which are specific to that jurisdiction's scenario. For example XBRL US developed and maintains the US GAAP taxonomy.

The SEC has mandated required reporting in the XBRL for registrants other than investment companies subject to a three-tier phased-in program beginning with fiscal periods ending on or after Jun. 15, 2009. The three tiers of the SEC Mandate Timeline are:

Tier 1: Domestic and foreign large accelerated filers that file financial statements presented in accordance with U.S. GAAP and have a worldwide public float above $5 billion as of the end of the second fiscal quarter of their most recently completed fiscal year, beginning with the first fiscal period ending on or after Jun. 15, 2009.

Tier 2: All other domestic and foreign large accelerated filers that file financial statements prepared in accordance with U.S. GAAP, beginning with the first fiscal period ending on or after Jun. 15, 2010.

Tier 3: All remaining filers that file financial statements prepared in accordance with U.S. GAAP, including smaller reporting companies, and all foreign private issuers that prepare their financial statements in accordance with IFRS as issued by the LAS B, beginning with the first fiscal period ending on or after Jun. 15, 2011.

In Phase 1 (referred to herein as “Year 1”), filers are expected to tag all numbers in their face financials as well as block tag (putting one tag against the complete note) all the Notes to Financial Statements. In Phase 2 (referred to herein as “Year 2”), filers are expected to additionally tag (1) each significant accounting policy within the significant accounting policies footnote tagged as a single block of text; (2) each table within each footnote tagged as a separate block of text; and (3) within each footnote, each amount (i.e., monetary value, percentage, and number) separately tagged.

It is expected that filers will have about 300-400 pieces of information to be tagged in Year 1. In Year 2 it is expected that filers will have to tag about 2,000-3,000 pieces of information. So as can be seen there is a significant increase in the number of tags from Year 1 to Year 2. In addition to the increase in tagging complexity and effort, filers are expected to file the XBRL version of their financial reports on the same-day as the HTML version of the financial reports.

While the foregoing exemplifies a US-based public company corporate filing, the challenges described apply to XBRL-based reporting scenarios world-wide.

Filers can comply, leveraging three kinds of solutions, namely, a bolt-on approach, an outsourced approach, and an embedded approach.

In the “bolt-on” approach, organizations use a standalone tool which reads Excel/Word documents and provides a XBRL-only tagging solution. Since these are built as general purpose tagging tools they fail to incorporate the financial reporting context when performing the tagging. In addition some of them require re-tagging every period which can be cumbersome with a large number of tags.

By outsourcing, customers rely on the external service provider to handle the XBRL tagging. While this can work well for the initial tagging requirements in the first year; however, given the ramp-up of XBRL requirements in the second year, these organizations may find themselves at a disadvantage because they have outsourced their XBRL capabilities and thus have not built up expertise in the application and use of XBRL. In addition, outsourcing costs can be significant as well.

In the embedded approach, XBRL tagging becomes just another capability, and the tagging features are embedded inside the financial report preparation process, thereby providing a more integrated experience to the end-user.

In the light of above requirements, particularly the large number of tags and the requirement for same-day filing, there is a need for a tagging solution where the majority of the tagging-related constructs can be setup once and tags can be rolled forward every period.

### SUMMARY

The present invention, accordingly, provides an XBRL tag which is re-usable across period boundaries, the tag including at least one definitional attribute and at least one transactional attribute, wherein the at least one transactional attribute is updated for each period.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic diagram of a tag embodying features of the present invention; and

FIG. 2 is a schematic diagram of the tag of FIG. 1 defined once and updated for a subsequent period in accordance with principles of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

In the discussion of the FIGURES, the same reference numerals will be used throughout to refer to the same or similar components.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

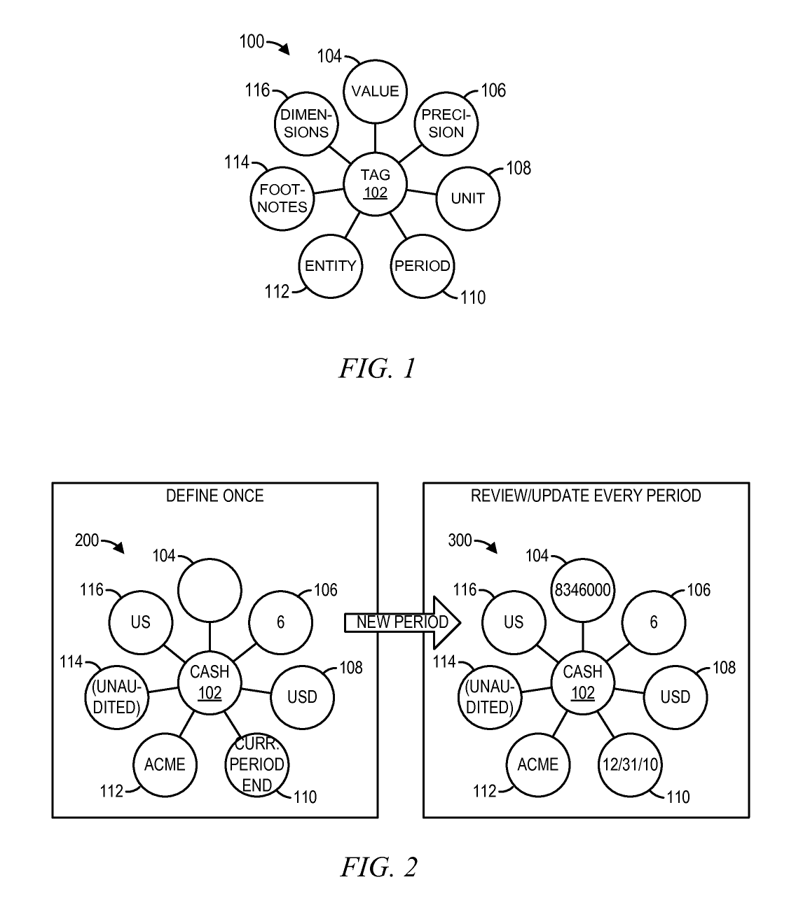

Referring to FIG. 1 of the drawings, the reference numeral 100 generally designates a XBRL, tag having multiple pieces of data (referred to herein as “attributes”) which need to be filled-in. The illustration below shows how a number reported in the balance sheet gets translated into XBRL.

The element or tag 102 is the name of the tag as represented in the taxonomy.

The value 104 is the completely scoped value being reported.

The number of decimals or precision 106 provides information on rounding and precision of numbers in the value 104.

The units 108 for the number being reported, such as, by way of example, U.S. dollars (“USD”).

The period 110 represents the date(s) for which content is being reported.

The entity 112 is the name of the filing entity.

The footnotes 114 could be any kind of “superscript footnotes” against the reported number.

The dimensions 116 indicate the level or granularity of the filing entity. For example, the level of the content being reported could be at the level of the filing entity or at a more granular level, such as a geographical region.

As mentioned above, a single number/content on an HTML report can translate into many attributes on a tag, some of which attributes generally do not change during subsequent periods, and some of which attributes do change during subsequent periods.

Within financial reports, there are constructs which are independent of the period and those which are specific to a period. For example, the actual structure of a financial report (like the line items within a balance sheet) remains largely the same but the actual values and dates vary on a per period basis. Hence there are really two kinds of constructs involved, namely, templates and instances.

Templates contain the overall structure, outline, and thinks anything that doesn't vary by period. By way of example, a 10Q template. A technical term for anything defined in the template is also referred to herein as “definitional”. The template comprises the following parts of the tag, namely, choosing the element 102, setting units 108, setting the precision 106, setting dimensions 116, setting relative period (discussed in further detail below). It is noted that the user may “override” tag attributes set in the template (for addressing corner cases).

And instance contains a “period specific variation” of that template. By way of example, a 10Q for the period ending Dec. 31, 2010. A technical term for anything defined in the instance itself is also referred to herein as “transactional”. The instance comprises the following parts of the tag, namely, setting values (attribute 104) and changing period values (attribute 110) as required. Values are brought in any way as part of the financial reporting process so there is nothing special for XBRL tags.

Unity Xtensible Financial Reporting (“XFR”, a Trintech® technology which automates complex financial reporting processes) embraces this sort of strategy, so that meta-data can be defined once and re-used over and over again every period. Building on that strategy for XBRL tagging, there are some attributes of the tag which belong in the template and some attributes which belong in the instance itself. Some attributes will overlap between the template and an instances.

The strategy for periods requires further explanation. Since there can be a lot of period data within a financial report (and hence within the XBRL tagged document), there is a need for allowing users to setup “relative periods” once in the template setup, but also allow for actual date values to be automatically populated based on a handful of dates which change every period. As most financial reports are analyzed, there are a handful of actual date variations which are re-used across reporting periods. With reference to the following table, by way of example, the “Current reporting period” is a construct which can be used when setting up the tags in the template, but actual values will vary every period. So there may be hundreds of actual dates in the report, but the user only has to choose one of the relative periods for tagging in the template and specify period specific dates only for the use. The system of the invention would automatically populate date-specific tag attributes for all of them.

| Relative | Q example | | K example | |
|---|---|---|---|---|
| Period Type | Start Period | End Period | Start Period | End Period |
| Current reporting period | 7/1/2009 | 9/30/2009 | 1/1/2009 | 12/31/2009 |
| Previous reporting period | 4/1/2009 | 6/30/2009 | 1/1/2008 | 12/31/2008 |
| (Y-1) reporting period | 7/1/2008 | 9/30/2008 | 1/1/2008 | 12/31/2008 |
| Current YTD | 1/1/2009 | 9/30/2009 | 1/1/2009 | 12/31/2009 |
| Previous YTD | 1/1/2008 | 9/30/2008 | 1/1/2008 | 12/31/2008 |
| Current fiscal year | 1/1/2009 | 12/31/2009 | 1/1/2009 | 12/31/2009 |
| Previous Fiscal year | 1/1/2008 | 12/31/2008 | 1/1/2008 | 12/31/2008 |

With reference to FIG. 2, in the operation of the invention, the tag 200 includes template attributes 106, 108, 112, 114, and 116 which remain substantially constant from one period to another period. Instance attributes 104 and 110 are the only attributes that change from one period to the next. As shown in FIG. 3, the attributes 104 and 110 of the tag 300 are reviewed and updated with content in a new period, which content may change in each subsequent period.

By the use of the present invention, users can setup a substantial amount of tag-specific information once (or even less frequently) within a template, and the system of the invention would roll-forward all such tagging information every period without a large amount of manual work every period.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A system for re-using XBRL tags across period boundaries, the system comprising tag having at least one definitional attribute, and at least one transactional attribute.

2. A method for re-using XBRL tags across period boundaries, each of said tags having at least one definitional attribute, and at least one transactional attribute, the method comprising updating said at least one transactional attribute for each period.

3. A computer program product for re-using XBRL tags across period boundaries, each of said tags having at least one definitional attribute, and at least one transactional attribute, the computer program product having a medium with a computer program embodied thereon, the computer program comprising computer program code for updating said at least one transactional attribute for each period.
